(19) United States
(12) Patent Application Publication
(10) Pub. No.: US 2004/0095226 A1
(43) Pub. Date: May 20, 2004

(54) Motion alarm clock

(76) Inventor: Rodney Moore, Concord, CA (US)

Correspondence Address: Rodney Moore, 1238 Pine Shadow Lane, Concord, CA, 94521, US

(21) Appl. No.: 10/295,052

(22) Filed: Nov. 15, 2002

(51) Int. Cl. G08B 1/00

(52) U.S. Cl. 340/309.16; 340/407.1

(57) ABSTRACT

A mechanical device engaged to awaken the individual using the pillow. The mechanism includes a timing device that can be set to activate the rollers and track inside of the pillow. The rollers can be set at different sizes and speeds depending on the difficulty of waking up the user. The speed and size may be set to increase in intensity if not deactivated (“turned off”) by user. The track has the dual purpose of guiding the rollers or vibrating to wake the user. The duration (amount of time e.g. 5 minutes) that the rollers and vibrators in the mechanism are active can be adjusted by user. The mechanism will be enclosed in a malleable package (e.g. possibly plastic or rubber) that can be inserted into the pillow (probably by the original equipment manufacturer/OEM), into a pillow case (probably by an end user), or used directly. The “on-off” switch will also be included in the mechanism making the entire wake-up process completely self-contained in a single mechanism.

### TECHNICAL FIELD

This invention relates to a pillow (or pillow-filler) with a self-contained, silent alarm that can be set to awaken the user at a specific time with configurable intensity by using a vibrating device or pre-selected sized roller moving at a pre-selected speed.

### BACKGROUND

Current methods of waking individuals rely primarily on noise. There are a number of inefficiencies that this method creates. Noise awakens individuals within any given vicinity indiscriminately. Frequently, noise is startling, shocking and disruptive. The source of the noise typically requires a separate independent mechanism (e.g. alarm clock or radio) that cannot be easily incorporated into one of the basic sleeping apparatus (e.g. pillow, blanket, bed).

It seems straightforward that facilitating an easier, more peaceful method of waking up could profoundly improve the quality of life. A large majority of individuals rely on some type of alarm to wake them up; waking up is a fairly difficult task for most and can set the tone for the remainder of the day; thus the statement, “Did you wake up on the wrong side of the bed this morning?” This idea combines the functionality of a pillow and an alarm clock.

### OBJECTS AND ADVANTAGES

Accordingly, several objects and advantages of this invention are:

Enable a self-enclosed object that will perform the wake-up function versus a separate, independent and additional piece of apparatus.

Ability to perform a focused wake-up function for a specific individual without impacting others in the near vicinity.

Ability of deaf individuals to have a simple wake-up mechanism.

Ability to wake-up in less stressful manner through a preset list of options.

Ability to have a reliable wake-up source (due to enclosed batteries) in the event of mid-night power outages.

Illustrative applications of the invention:

Although the use of this invention is fairly self-explanatory, the criticality of this new method of waking up may be more elusive. Almost every individual above the age of teenager in the United States uses a wake-up device. It has been a tradition and an accepted paradigm that wake-up methods must include noise or a separate piece of apparatus. However, this function can be consolidated into the pillow to become a more effective operation. This invention enables a revolutionary change in a basic function resulting in a number of improvements in quality of life:

Self-contained mechanism is easily portable

Alarm pillow can be taken on trips with built-in alarm.

An individual can wake-up without disturbing surrounding individuals

Each individual can set their own personal alarm

An individual does not have to be “jarred” awake through a single pre-set noise level

Individuals can select their own pace of waking up

Deaf individuals would have a method of waking

Waking up should not be tied to audible methods; motion has a broader base.

Power outages would no longer affect waking times

Many individuals each year wake up late due to power outages that occur in the middle of the night; self-enclosed batteries circumvent this issue.

### BRIEF DESCRIPTION OF THE DRAWINGS

FIG. 1 is a flowchart of use for the wake-up mechanism

FIG. 2 is a view of the mechanism track inside of the pillow that will direct the speed and direction of rollers (or the intensity of the vibrator)

FIG. 3 shows the functionality of control component that enables the user to set preferences

FIG. 4 represents a view of single-size rollers in mechanism during dormant state

FIG. 5 represents a view of multi-size rollers in mechanism during dormant state

FIG. 6 is an active view of multi-size rollers in mechanism utilizing smallest size rollers for the slightest motion resulting in the least disruptive disturbance

FIG. 7 is an active view of multi-size rollers in mechanism during largest size rollers for the greatest amount of motion to wake-up the soundest sleepers

FIG. 8 reflects the malleable container enclosing the alarm mechanism that will ensure safety and transferability between pillows

### DETAILED DESCRIPTION OF THE PREFERRED EMBODIMENT

This invention begins with a new concept of awaking people via a mechanism within the pillow that activates motion (either rolling or vibration) instead of sound. An individual can set their pillow to begin motion at a specified time; the pillow can then increase in intensity and/or size until the individual is awakened or until an allotted time expires and the mechanism terminates.

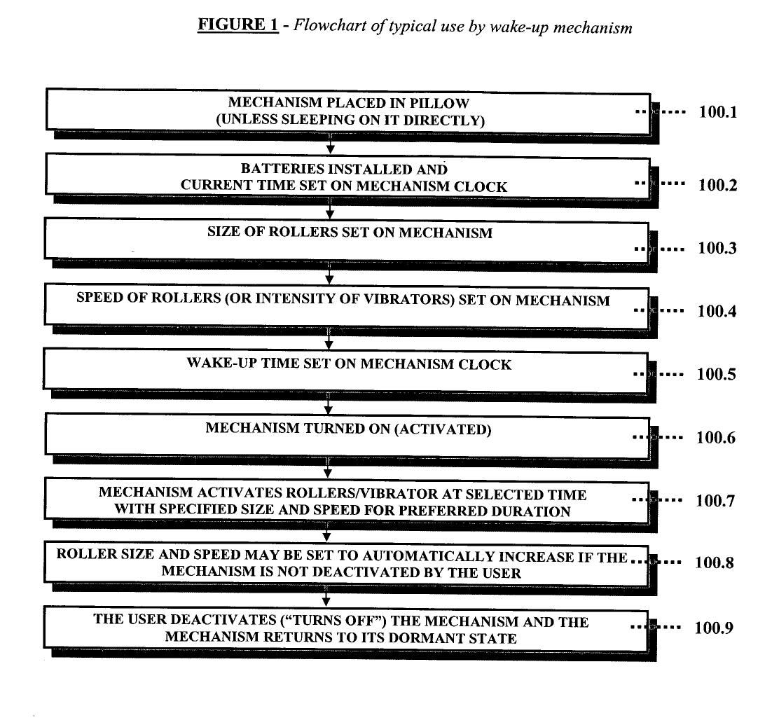

FIG. 1 shows a flowchart using the device to awaken the user.

100.1 Mechanism Placed in Pillow (unless sleeping on it directly) The device is enclosed in a “rubber type” covering that can be encased in a pillow or simply slid between the pillow and the pillow case.

100.2 Batteries Installed and Current Time Set on Mechanism Clock: The batteries allow self-generating power; also included is a clock that will run continuously on this device and be used to set the alarm for motion wake-up.

100.3 Size of Rollers Set on Mechanism: A comfortable and safe roller size can be pre-selected for optimal wake-up motion; the size of the rollers may increase with intensity if alarm not switched off within certain amount of time.

100.4 Speed of Rollers Set on Mechanism. If the rollers are not manually turned off within given amount of time, speed (intensity) of motion will increase until individual awakens and turns mechanism off (or the mechanism automatically terminates). The track can also be used for vibration and intensity can be selected as well.

100.5 Wake-up Time Set on Mechanism Clock: The individual will specify a time on the clock that they would like the motion wake-up to begin.

100.6 Mechanism is Turned On (Activated): Once times have been set, the mechanism is turned on, so that it will sound at the specified time.

100.7 Mechanism Activates Rollers at Selected Time with Specified Size and Speed for Preferred Duration: At the set time, the clock activates the rollers to begin motion.

100.8 Roller Size and Speed may be set to Automatically Increase if the Mechanism in not Deactivated by the User. If the individual does not awaken and turn off the mechanism, both the size of rollers and speed increase by pre-set timed intervals until the individual turns off the mechanism or the self-terminating criteria/time has transpired.

100.9 Roller Size The User Deactivates (“Turns Off”) the Mechanism and the Mechanism Returns to its Dormant State. When the user is awakened, they can terminate the motion by turning off the rollers; the time can then be reset or simply reactivated for a following time.

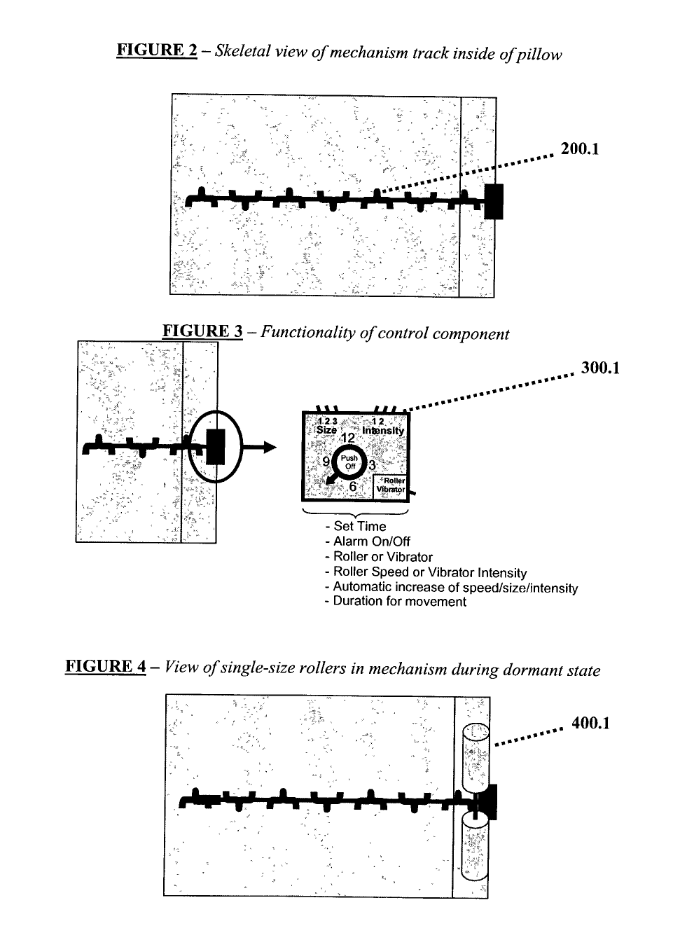

FIG. 2 is a skeletal view of the “mechanism track” that inside the encasing.

Track to direct rollers from one side to the other and back again: This track would be made of flexible material, but the rollers would be fastened securely to adhere closely to the track. The track will also be used as the vibration device to give the user an alternative method of waking.

FIG. 3 reflects the functionality of the control component.

The control component is battery operated enabling the mechanism to be transportable and self-supporting in case of electrical outages.

The mechanism has a clock to keep current time. The clock can be set with trigger to begin the motion of the rollers.

The control mechanism will enable the user to select the initial size and speed of the motion as well incremental and termination times.

FIG. 4 shows the rollers in a dormant state surrounding the control component.

The rollers will be somewhat soft/malleable which will enable them to protect the control component from being damaged as well as protecting the user from the control compartment.

FIG. 5 shows an active view of the initial stage of the mechanism while it is utilizing the smallest rollers.

These smallest rollers would proceed along the track at a rate that was pre-set by the user.

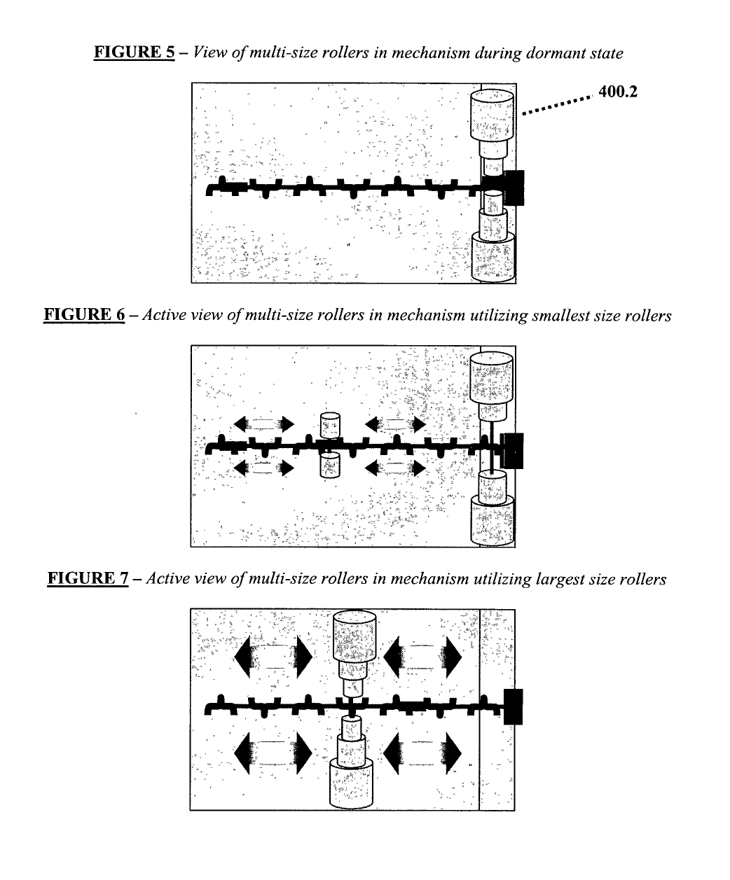

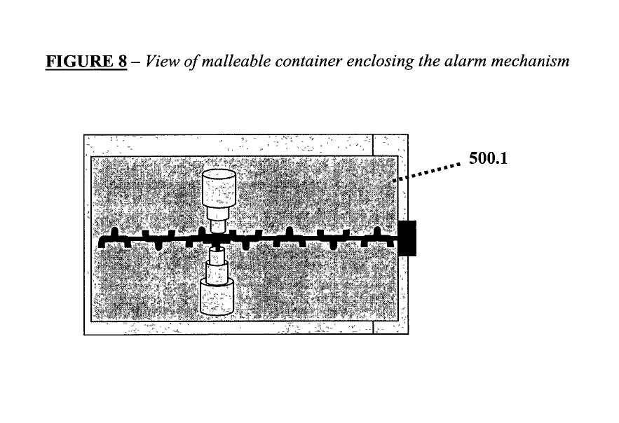

FIG. 6 shows an active view of the larger rollers of the mechanism being engaged.

There are several ways that the rollers could increase in size; probably a pin from the central control mechanism will be released to push through increasing sizes of outer rollers. When the mechanism is turned off, the pins reset to the user's setting.

FIG. 7 shows a view of the malleable container that encloses the wake-up mechanism.

This malleable protective covering could be enclosed in pillows or simply slid between the pillow and pillow case.

### DESCRIPTION OF THE INVENTION

This invention entails waking individuals without the use of noise. The four primary components of the device are the guidance track (200.1), the control mechanism (300.1), the rollers (400.1), and the encasing (500.1). The encasing will be able to be manufactured within actual pillows or placed between pillow cases and pillows. The single interface to the user will be the control mechanism. This control mechanism will be battery operated. The control mechanism will consist of five primary options:

A. On/Off—This will be a switch or possibly a button with protection against being turned on or off inadvertently.

B. Clock—This will not only display the current time, but also allow an commencement time to be designated. At the appointed time, the mechanism will progress the rollers across the track repetitively.

C. Rollers Speed/Size—Individuals can indicate roller or vibration as the method of waking. The user will have two options in regard to the rollers; they can select the optimal size of rollers and speed of movement that will wake them. The intensity of vibration can also be selected.

D. Automatic Adjustment—Users will have the option to increase the size and speed of the rollers at specified intervals (e.g. after 5 minutes increase the size of the roller). This will be advantageous if the original selection is not enough to wake the individual; it also allows the individual to select the slightest settings and wake with the least amount of motion necessary.

E. Automatic Discontinue—If the roller is not shut-off by the user, it will automatically stop after a pre-determined point of time.

What is claimed is:

1. The ability to awaken individuals using rolling motion enclosed in a pillow versus external noise.

2. The ability to awaken individuals using a vibration enclosed in a pillow versus external noise.

3. The ability to intensify the wake-up motion through pre-set, timed speed and size intervals.
